(19) United States
(12) Patent Application Publication
(10) Pub. No.: US 2006/0047844 A1
(43) Pub. Date: Mar. 2, 2006

(54) One step approach to deliver multimedia from local PC to mobile devices

(76) Inventor: Li Deng, San Jose, CA (US)

Correspondence Address: Li Deng, 1047 S. Blaney Ave., San Jose, CA, 95129, US

(21) Appl. No.: 10/929,310

(22) Filed: Aug. 30, 2004

(51) Int. Cl. G06F 15/16

(52) U.S. Cl. 709/231

(57) ABSTRACT

A method, apparatus, html form, image processing function, web server is directed to enabling one step uploading, format conversion, and delivering of multimedia to mobile devices. A web form is provided for users to upload multimedia from their local desktop computing device. Also provided in the form are input fields for users to enter their phone numbers and their service providers. Upon submitting the form, multimedia is uploaded to the server. The multimedia is then stored in the server. The server sends a short message, such as SMS message, to the mobile device that includes a hook. In one embodiment, the message hook is a URL that identifies the multimedia that is uploaded. If the message hook is selected at the mobile device, the server employs the index to access the multimedia on the server. The accessed multimedia is processed and converted to the format that can be readily saved, viewed, and played on the mobile device. The formatted multimedia is then sent back to the mobile device. The mobile device saves the multimedia.

### FIELD OF THE INVENTION

The present invention relates generally to wireless mobile devices with multimedia capabilities, and more particularly but not exclusively to providing a simplified scheme to upload, convert, and deliver multimedia on user's desktop computing devices to multimedia capable phones in one step.

### BACKGROUND OF THE INVENTION

In today's society, mobile computing devices are becoming increasingly more powerful. The greatest manifestation is the glue between unwired universes to the Internet domain and the advent of wireless multimedia capabilities. The newest versions of mobile wireless devices are capable of capturing color photos, sharing photos, upload photos into online albums, and saving photos as screen savers and wall papers.

Wireless phones with embedded cameras can take color pictures; upload them into online albums, and save them as screensavers or wallpapers. However, a lot of high quality multimedia such as high resolution digital photos, audios, webcam images, and videos is saved in the user's personal computers. There is clearly a need to provide a seamless way to make the personal multimedia available to the owner's multimedia capable wireless devices so that they can be available anytime, every time, and all the time. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment for managing a one step process of delivering a multimedia in a user's desktop computing device to the user's mobile device.

FIG. 4 illustrates one embodiment of logical data flows in another environment for practicing the invention, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards a client, server, and method for enabling one step uploading multimedia from user's desktop computing devices to server, converting the multimedia into format that suitable for storing, viewing, playing on mobile devices, and then delivering to mobile devices. The path or location of multimedia on user's desktop computing device is entered by users in a web form. Also entered in the same form is the mobile device number. In one embodiment, this is the mobile phone number. Users have the option to enter the carrier info. If the carrier info is not entered, the carrier info will be inferred from the phone number.

Upon successful submission of the form, the multimedia will be uploaded to the server. The uploaded files will then be saved. A short message, such as an SMS message, MMS message and the like will be delivered to the mobile devices. The short message may comprise a hook, such as a Uniform Resource Locator (URL), a script, an executable script, program, and the like, that enables access to the multimedia just uploaded. The hook may further include an index usable to locate and access the multimedia. Upon selection of the hook, the server converts the multimedia into a format that can be stored, viewed, and played on the mobile device. The converted multimedia is then sent back to mobile browser, and the like.

Illustrative Operating Environment

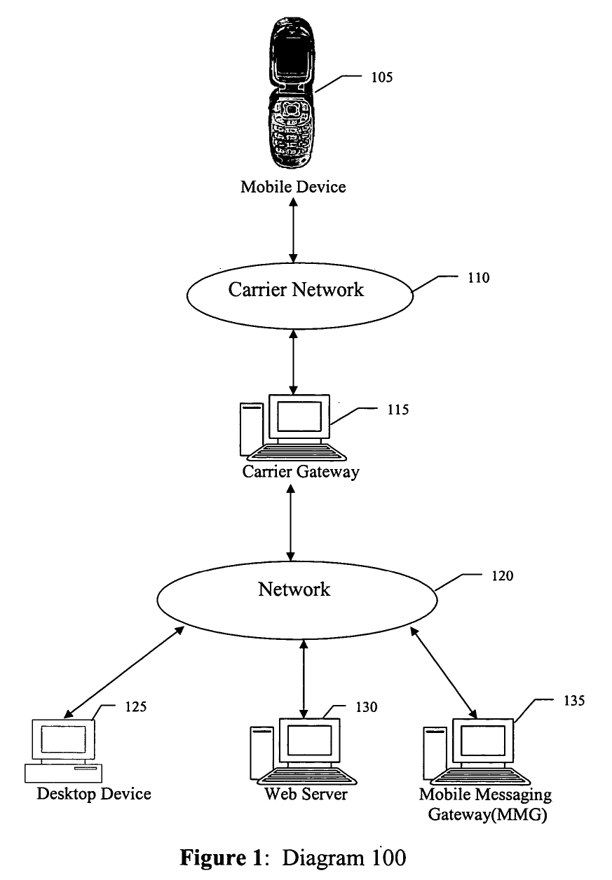

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, diagram 100 includes mobile device 105, carrier network 110, carrier gateway 115, network 120, Mobile Messaging Gateway (MMG) 135, Web Server 130, and desktop computing device 125. Carrier network 110 is in communication with mobile device 105 and Carrier Gateway 115. Network 120 is in communication with and enables communication between carrier gateway 115, MMG 135, Web Server 130, and desktop computing device 125.

Generally, mobile device 105 may include virtually any portable computing device capable of connecting to another computing device to send and receive a message. Such devices include cellular telephones, smart phones, display pagers, radio frequency (RF) devices, infrared (IR) devices, integrated devices combining one or more of the preceding devices, and the like. Mobile device 105 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ WAP to fetch and display mobile markup languages such as Handheld Device Markup Language (HDML), Wireless Markup Language (WML), WMLScript, XHTML Mobile Profile, and the like.

Mobile device 105 may include a keyboard, mouse, speakers, a microphone, and an area on which to display information. Mobile device 105 may further include low-end devices that may have limited storage memory, reduced application sets, low bandwidth for transmission of a communication, and the like.

Mobile device 105 may provide a message, network packet, and the like, that includes a device identifier, such as a Mobile Identification Number (MIN). MINs are provided with each WAP request and uniquely identify each handset. Mobile device 105 may further provide a phone number in addition to the device identifier. In one embodiment, mobile device 105 includes a device identification component configured to provide the MIN, phone number, and the like.

Mobile device 105 may be configured to receive a message, such as through a Short Message Service (SMS), Multimedia Message Service (MMS), and the like, from the other computing device, such as MMG 135, and the like. In one embodiment, the message includes a hook, such as a URL, script, program, and the like. Mobile device 105 may be further configured to employ the hook to request access to another piece of info, such as from MMG 135, and the like. In one embodiment, the other info is a multimedia file. However, the present invention is not limited to multimedia. Multimedia, and virtually any other content type, and the like, may be accessible through the included URL content hook. For example, the content may include, but not be limited to, a document, an audio file, a video file, a graphics file including but not limited to a bitmap file, a jpeg file, and the like, a video file, a File Transfer Protocol command, a compressed file, and the like.

Mobile device 105 may further include a client application, and the like, that is configured to manage the actions described above for mobile device 105.

Carrier network 110 is configured to couple mobile device 105 and its components with carrier gateway 115. Carrier network 110 may include any of a variety of wireless sub-networks that may further overlay stand-alone ad-hoc networks, and the like, to provide an infrastructure-oriented connection for mobile device 105. Such sub-networks may include mesh networks, Wireless LAN (WLAN) networks, cellular networks, and the like.

Carrier network 110 may further include an autonomous system of terminals, gateways, routers, and the like connected by wireless radio links, and the like. These connectors may be configured to move freely and randomly and organize themselves arbitrarily, such that the topology of carrier network 110 may change rapidly.

Carrier network 110 may further employ a plurality of access technologies including, but not limited to, 2nd (2G), 2.5 (2.5G), 3rd (3G) generation radio access for cellular systems, WLAN, Wireless Router (WR) mesh, and the like. Access technologies such as 2G, 2.5G, 3G, and future access networks may enable wide area coverage for mobile devices, such as mobile device 105 with various degrees of mobility. For example, carrier network 110 may enable a radio connection through a radio network access such as Global System for Mobil communication (GSM), General Packet Radio Services (GPRS), Enhanced Data GSM Environment (EDGE), Code Division Multiple Access (CDMA), Code Division Multiple Access 2000 (CDMA 2000), Wideband Code Division Multiple Access (WCDMA), and the like. In essence, carrier network 110 may include virtually any wireless communication mechanism by which information may travel between mobile device 105 and carrier gateway 115.

Carrier gateway 115 may include any computing device capable of connecting with mobile device 105 to enable communications with another computing device, such as MMG 135, Web Server 130, PC desktop 125, another mobile device (not shown), and the like. Such devices that may operate as carrier gateway 115 include, but are not limited to, personal computers, desktop computers, multiprocessor systems, microprocessor-based or programmable consumer electronics, network PCs, servers, and the like.

Carrier gateway 115 typically includes a carrier level service provider's computing device, and related infrastructure. Carrier gateway 115 may be configured to receive a network packet, and the like, from mobile device 105. The network packet, and the like, may include information associated with mobile device 105, such as a device identifier, and the like. The network packet may further include information associated with an end-user of mobile device 105, such as a user account identifier, and the like. Carrier gateway 115 may include additional information in the network packet prior to sending the network packet towards another device, such as MMG 135, Web Server 130, and the like. The additional information may include carrier information including, but not limited to, a carrier gateway grouping, carrier type, carrier identifier, and the like.

Carrier gateway 115 may further receive a network packet from Web Server 130, MMG 135, PC desktop 125, and the like. The received network packet may include an SMS message, a mobile browser readable message, and the like.

Network 120 is configured to couple MMG 135, Web Server 130, PC desktop 125, and the like, with carrier gateway 115. Network 120 is enabled to employ any form of computer readable media for communicating information from one electronic device to another. Also, network 120 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In essence, network 120 includes any communication method by which information may travel between carrier gateway 110, MMG 135, Web Server 130, desktop computing device 125, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal.

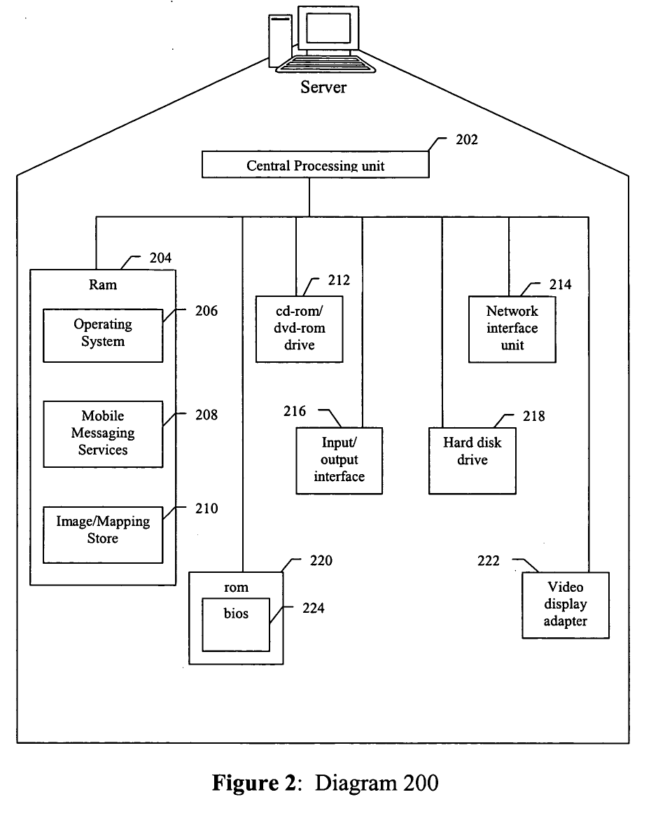

One embodiment of MMG 135 is described in more detail below in conjunction with FIG. 2. Briefly, however, MMG 135 may include any computing device capable of communicating with mobile device 105. Such devices include personal computers, desktop computers, multiprocessor systems, microprocessor-based or programmable consumer electronics, network PCs, servers, and the like.

MMG 135 may be further configured to receive a message notification associated with a message from Web Server 130. In response, MMG 135 may format a short message, such as a SMS message, MMS message, or the like, and send the formatted message towards mobile device 105. In one embodiment, the short message includes a Uniform Resource Locator (URL). In another embodiment, the short message is a SMS message that includes the URL.

The URL may further include an index associated with a multimedia file stored on the server side. MMG 135 may determine the index based, in part, on information received from Web Server 130, including, but not limited to, the identifier that points to a storage location for the multimedia file. The index may be generated to map a relationship between the identifier and the device identifier, based on any of a variety of mechanisms, including, but not limited to a counter, a one-way hash, and the like. MMG 135 may employ a mapping store (not shown) to save the mapping, including the index, the location of the multimedia file, and the device identifier.

Web Server 130 may include any computing device capable of connecting to mobile device 105, MMG 135, and the like, to receive a request, process a request, and send response back to the mobile devices and the like. Such devices include personal computers, desktop computers, multiprocessor systems, microprocessor-based or programmable consumer electronics, network PCs, servers, and the like.

Web Server 130 may be configured to receive the request, for example, from PC desktop 125. Web Server 130 may determine whether the intended recipient of the message is configured to receive the message in a mobile browser readable format.

Web Server 130 may store the uploaded multimedia at a location that may be determined based, in part, on at least one of the user id, file identifier, device identifier, and the like. In one embodiment, MMG 135 may store the multimedia at a server that may be one of a plurality of servers (not shown), or the like.

Although MMG 135 and Web Server 130 are illustrated as distinct computing devices, the present invention is not so limited. For example, the functionality of MMG 135 and Web Server 130 may be associated with a single computing device, or spread across multiple computing devices, without departing from the scope of the invention.

Desktop computing device 125 represents virtually any device enabled to make a network request to another computing device, including but not limited to Web Server 130, MMG 135. Such devices include personal computers, webcam, desktop computers, multiprocessor systems, microprocessor-based or programmable consumer electronics, network PCs, servers, and the like.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention. Server 200 may represent, for example, MMG 135 of FIG. 1.

Server 200 includes processing unit 202, video display adapter 222, and a mass memory, all in communication with each other via a bus. The mass memory generally includes RAM 204, ROM 220, and one or more permanent mass storage devices, such as hard disk drive 212, tape drive, optical drive, and/or floppy disk drive. The mass memory stores operating system 206 for controlling the operation of server 200. Any general-purpose operating system may be employed. Basic input/output system (“BIOS”) 224 is also provided for controlling the low-level operation of server 200. As illustrated in FIG. 2, server 200 also can communicate with the Internet, or some other communications network, such as network 120 in FIG. 1, via network interface unit 214, which is constructed for use with various communication protocols including the TCP/IP protocol. Network interface unit 214 is sometimes known as a transceiver, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM or other optical storage, magnetic cassettes, magnetic tape, magnetic disk storage or other magnetic storage devices, or any other medium which can be used to store the desired information and which can be accessed by a computing device.

The mass memory also stores program code and data. One or more applications are loaded into mass memory and run on operating system 206. Examples of application programs include multimedia uploading programs, multimedia format converting programs, schedulers, database programs, web server programs, mobile markup language processing programs, SMS programs, MMS programs, and so forth. Mass storage may further include applications such as mobile messaging service 208 and multimedia mapping store 210.

Mobile messaging service 208 may further receive a mobile message, such as a message notification, indicating that a mobile device is enabled to receive a mobile browser readable message, that a message is available for the mobile device, and the like. Mobile messaging service 208 may also receive Meta information, such as an account id, multimedia identifier, and the like. Mobile messaging service 208 may associate a multimedia index with the message identifier, device identifier, MIN, account id, and the like. The index may be determined based on any of a variety of mechanisms, including a counter, a one-way hash, and the like. The index may then be stored in mapping store 210.

Mobile messaging service 208 may further format and provide a short message, such as an SMS message, an MMS message, and the like, to the mobile device associated with the other message. The short message may include a hook that enables access to the multimedia file. In one embodiment, the hook is a URL that includes the index that points to the multimedia stored on server.

Although illustrated in FIG. 2 as distinct components, mobile messaging service 208 and mapping store 210 may be arranged, combined, and the like, in any of a variety of ways, without departing from the scope of the present invention. Moreover, messaging service 208 and mapping store 210 may reside in one or more computing devices, substantially similar to server 200.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 216 for communicating with external devices, such as a mouse, keyboard, scanner, or other input devices not shown in FIG. 2. Likewise, server 200 may further include additional mass storage facilities such as CD-ROM/DVD-ROM drive 212 and hard disk drive 218. Hard disk drive 218 may be utilized to store, among other things, application programs, databases, registration information, messages, and the like.

Generalized Operation

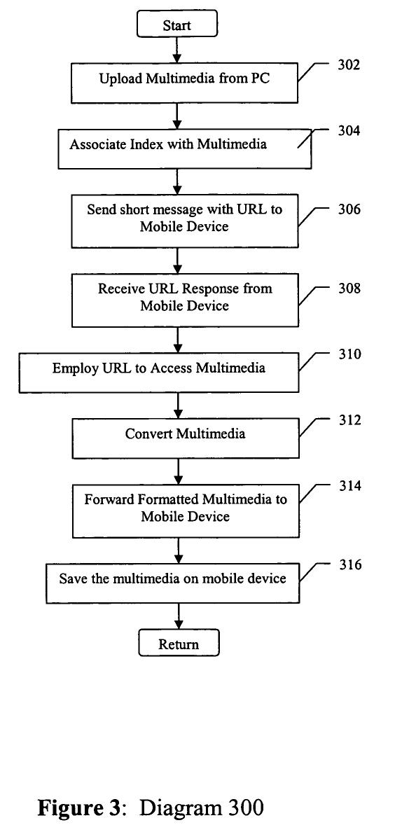

The operation of certain aspects of the present invention will now be described with respect to FIG. 3. FIG. 3 is a flow diagram generally showing one embodiment for a process of one step scheme uploading multimedia, entering mobile device info, delivering a hook to device, and then invoking the hook to request the multimedia.

The process 300 begins, after a start block, at block 302, where a user picks up a multimedia file from a location in the user's local hard disk, enters the device and service info about the mobile device that will receive the multimedia file.

For ease of understanding, the process 300 employs an SMS message to represent a short message, and a URL to represent the hook. However, the present invention is not so limited and virtually any messaging structure may be employed to provide the short message. Additionally, virtually any message hook may be employed to enable access to the other message, including a script, an executable script, a program, and the like.

Processing continues to block 304 where the multimedia is uploaded into server and stored. A device identifier associated with the mobile device is also forwarded to the server. The device identifier may include a MIN, a phone number, and the like. An index is generated. A SMS message is also generated. The SMS message contains a hook that includes the index. Processing next proceeds to block 306 where a notification SMS message is sent by the server to the mobile device associated with the phone number. In one embodiment, a URL is included in the notification SMS message.

Processing flows next to block 308, where the end-user requests the multimedia by responding to the URL within the notification SMS message. The server receives the request from the mobile device.

Processing next continues to decision block 310, where server uses the URL, the device info to access the multimedia pointed to by the hook contained in the URL. In one embodiment, the device identifier is sent to the server, with an HTTP request from the mobile device. The processing then flows to block 312, where the server uses the hook to load the multimedia into memory for further converting into the right format for the device. In one embodiment, the server uses the info sent as HTTP header to decide the format and size required for conversion.

At block 314, the multimedia that has been converted to the right format and size that can be readily saved, viewed, and played on mobile device. The converted file is sent back to mobile device.

At block 316, the multimedia is then received by the mobile device and saved into mobile device's resident memory. Processing then returns to a calling process to perform other actions.

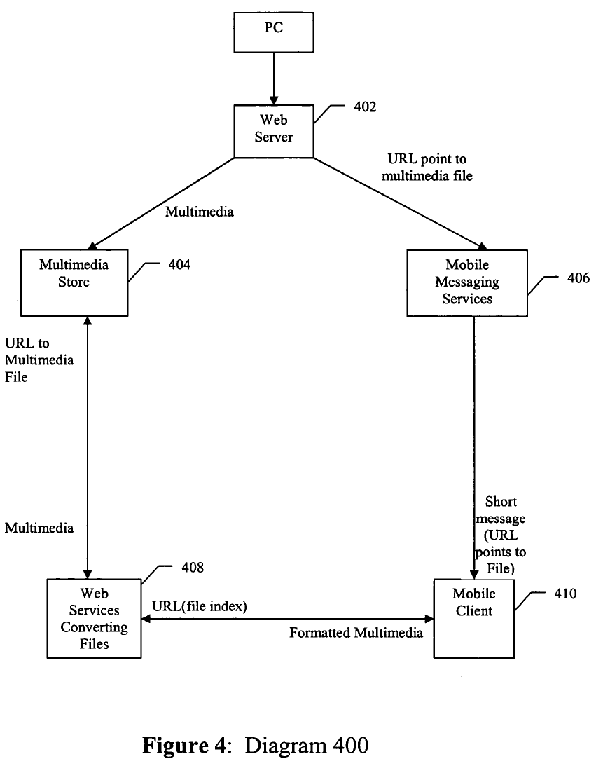

FIG. 4 illustrates a logical flow diagram generally showing one embodiment for a process of managing a one step scheme of uploading multimedia, entering mobile device info, delivering a hook to device, and then invoking the hook to request the multimedia file. Process 400 may be implemented within MMG 135 of FIG. 1.

For ease of understanding, process 400 employs an SMS message to represent a short message, and a URL to represent the hook. However, the present invention is not so limited and virtually any messaging structure may be employed to provide the short message. Additionally, virtually any message hook may be employed to access the other message, including a script, an executable script, program, and the like.

As shown in the figure, the flow 400 includes web server 402, multimedia Store 404, mobile client 410, web service 408, and Mobile Messaging Services 406. Mobile messaging service 406 is in communication with Web Server 402 and mobile client 410. Web service 408 is in communication with mobile client 410 and multimedia store 404.

Web services 408 may operate as a component within Web Server 402, or operate within another computing device, or as a combination of MMG 135 and the other computing device. Multimedia store 404 and mobile messaging service 406 are described above, in conjunction with FIG. 2.

FIG. 4 illustrates logical components that may be enabled to upload multimedia, save it into multimedia store, deliver a SMS message to mobile device, then fetch the multimedia from the device. As such, mobile client 410 may communicate with mobile messaging service to receive the SMS message with a hook. Mobile client 410 may also communicate with Web Services 408 to fetch the multimedia.

Web Server 402 hosts a form for users to pick up a multimedia and enter mobile device info in one step. Web Server 402 may receive an http request from a browser. In one embodiment, Web Server 402 is enabled to display a form upon an http request, and then process the form to upload and save the multimedia, to collect the info about mobile device. The uploaded multimedia is saved into the multimedia store. An index is then generated for the multimedia. A SMS message is then generated with the multimedia index embedded into the message. In one embodiment, the multimedia index is part of a URL embedded into the SMS message. The SMS message and mobile device info is then passed into Mobile messaging.

Mobile messaging service 406 may receive the message notification from Web Server 402, along with the multimedia identifier and the like. Mobile messaging service 406 may then generate a short message, such as an SMS message, and the like, that includes a hook, such as a URL. The short message, including the hook, and the like, may then be sent to mobile client 410.

Mobile client 410 may send a HTTP request that requests the URL from web service 408, where the HTTP request URL includes at least the hook to the stored multimedia. Mobile client 410 may further send its device identifier to web service 408.

Web service 408 may receive the HTTP request asking for the URL that includes a hook. Web service 408 may employ the associated information, including the hook, device identifier, and the like, to access the multimedia stored in the multimedia store 404. Web service 408 may convert and resize the multimedia into a format that can be readily saved, viewed, played on the mobile device. Web service 408 may then send the formatted multimedia to mobile client 410.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A method of enabling one step uploading multimedia from user's pc to server, converting multimedia into format that suitable for storing, viewing, playing back, and then delivering to mobile devices, comprising:
uploading multimedia from user's desktop computing device to server;
collecting user's mobile device info such as phone number and carrier;
sending a message to the mobile device, wherein the message includes a hook to the multimedia;
employing the hook to access the multimedia;
converting the multimedia into a format that can be saved, viewed, and played on the mobile device; and
sending the formatted multimedia to the mobile device.

2. The method of claim 1, wherein generating a hook that can be used to invoke a URL from device to request the server to covert the multimedia into a format that can be saved, viewed, and played on the mobile device.

3. The method of claim 1, wherein sending the SMS message further comprises:
associating an index with the multimedia uploaded and saved in the server;
associating the message index with the second message; and
sending the SMS message including the associated index to the mobile device, wherein the index is usable to locate the multimedia on the server.

4. The method of claim 1, wherein taking the info about the device on the fly and then converting and resizing multimedia file into a format that can be saved, viewed, and played on the mobile device.

5. The method of claim 1, wherein the uploaded multimedia is stored in a multimedia store.

6. The method of claim 1, wherein the hook further comprises at least one of a Uniform Resource Locator (URL), a script, and an executable program.

8. The method of claim 1, wherein the hook further comprises an index associated with the multimedia, and a URL.

9. The method of claim 1, wherein the notification message further comprises at least one of an SMS message, and an MMS message.

10. The method of claim 1, wherein the notification message further comprises an index associated with the multimedia, wherein the index is employable to locate the multimedia.

11. The method of claim 1, receiving the multimedia file on the server further comprises:
uploading the multimedia into web server;
storing the multimedia at a multimedia store; and
associating an identifier with the location of the stored multimedia.

12. A client adapted for use in a mobile device to receive messages from a server over a network, the client being configured to perform actions, comprising:
receiving a notification message from the server, wherein the notification first message includes an hook;
employing the hook to access the multimedia, wherein the multimedia is converted and resized into a format that can be readily saved, viewed, and played on mobile device.

13. The client of claim 12, wherein the multimedia is converted and resized according to the mobile device info received on the fly when the hook is invoked from devices to get the multimedia.

14. The client of claim 13, wherein the hook further comprises a Uniform Resource Locator (URL).

15. The client of claim 14, wherein the URL further comprises an index associated with the multimedia.

16. The client of claim 15, wherein the notification message further comprises at least one of an SMS message, and a MMS message.

17. A server for managing a communication with a mobile device over a network, comprising:
a transceiver for receiving and sending messages to the mobile device; and
a transcoder that is configured to perform actions, including:
delivering a notification message to the mobile device, wherein the notification message includes a hook;
handling http request from the mobile device requesting for the multimedia file using the hook;
employing the hook to enable access to the multimedia;
collecting characteristics of the device on the fly.
converting and resizing the multimedia using collected device characteristics.

18. The server of claim 17, wherein the hook further comprises at least one of a Uniform Resource Locator (URL), a script, and an executable program.

19. The server of claim 17, wherein the notification message further comprises at least one of an SMS message, and an MMS message.

20. The server of claim 17, wherein the hook further comprises an index associated with the multimedia, wherein the index is employable to locate the multimedia.
